(19) United States
(12) Patent Application Publication
(10) Pub. No.: US 2008/0185363 A1
(43) Pub. Date: Aug. 7, 2008

(54) Method and system of making metal casing

(75) Inventors: Yi-Sheng Yu, Taoyuan City (TW); Hsu-Pin Kao, Pingjhen City (TW); Kai-Hsiang Hsu, Tucheng City (TW); Chin-Ho Kuo, Gueishan Township (TW)

Correspondence Address: BIRCH STEWART KOLASCH & BIRCH, PO BOX 747, FALLS CHURCH, VA, 22040-0747, US

(73) Assignee: MARKETECH INTERNATIONAL CORP.

(21) Appl. No.: 12/003,737

(22) Filed: Dec. 31, 2007

(30) Foreign Application Priority Data
Feb. 6, 2007 (TW) 096104209

(51) Int. Cl. B23K 26/06

(52) U.S. Cl. 216/41; 216/94; 219/121.68

(57) ABSTRACT

The invention provides a method of making a metal casing, including the following steps: (a) providing a roll of metal sheet; (b) sequentially pulling out a part of metal sheet from the roll of metal sheet; (c) etching a plurality of holes on the part of metal sheet; and (d) forming the part of metal sheet into the metal casing. Step (d) includes: implementing a surface treatment on the part of metal sheet and press forming the part of metal sheet into the metal casing. Therein the steps of the surface treatment and the press forming can be exchanged. Therefore, the method continuously makes the metal casing and avoids management problems of intermediate products induced in the process of a traditional production.

### BACKGROUND OF THE INVENTION

1. Field of the Invention

This invention relates to a method of making a metal casing and, more particularly, to a method of continuously making a metal casing by etching a plurality of holes.

2. Description of the Prior Art

The casings of apparatuses are generally made of plastic materials or metal materials, such as the front frame of a television. If made of plastic materials, the front frame of the television first is injected by a mold and then finished the surface treatment by spraying paint. Although the process is simple, the costs of the plastic molds are very expensive. Moreover, many defects are easily induced in the injected large sized plastics, such as deformation, distortion, bad binding of filler, bubble, aperture, etc., to lower the yield rate of products and increase the costs. Especially, in the thin plate structure, the stability of plastic materials seriously influences the stability of injection and the quality of the products.

If made of metal materials, the front frame of the television is often made by press forming a metal sheet and then implemented other surface treatments. Although the processed front frame has better burnish and quality, it requires more traditional procedures. And the factories that are responsible for each procedure are usually independent and dispersive; it causes the costs of transportation, manufacturing, and management of intermediate products. Compared with the front frame made of plastic materials, the product unit cost of the front frame made of metal materials is higher; however, the life time is longer and the quality of products is stable.

Moreover, most of the front frames of the televisions are usually designed to have more than one speaker meshes. The speaker meshes and the front frames which are made by foregoing making methods can be separately produced, and the speaker meshes are locked to or stick to the front frames after all. As a result, it not only adds another procedure but also increases a process variation. That is to say, the yield rate of products will decrease, and the product unit cost will increase.

Accordingly, it is necessary to provide a new process of metal casing to reduce process variation and improve the yield rate of products, so as to solve the foregoing problems.

### SUMMARY OF THE INVENTION

One scope of the invention is to provide a method and a system of making a metal casing.

Another scope of the invention is to provide a method and a system of continuously making a metal casing by etching a plurality of holes.

The method, according to the invention, of making a metal casing includes steps of: (a) providing a roll of metal sheet; (b) sequentially pulling out a part of metal sheet from the roll of metal sheet; (c) etching a plurality of holes on the part of metal sheet; and (d) forming the part of metal sheet into the metal casing. The step (d) includes: implementing a surface treatment on the part of metal sheet; and press forming the part of metal sheet into the metal casing. Therein the steps of the surface treatment and the press forming in the step (d) can be exchanged. That is to say, the step (d) includes: press forming the part of metal sheet into a predetermined casing; and implementing a surface treatment on the predetermined casing to generate the metal casing.

Moreover, the step (c) includes steps of: coating a photoresist material on the part of metal sheet; exposing the photoresist material by a mask; developing the photoresist material; etching the part of metal sheet; and removing the photoresist material from the part of metal sheet. Furthermore, the surface treatment within the step (d) can be a satin finishing treatment, a sand blasting treatment, a spray anodizing treatment, or a paint baking treatment.

The system, according to the invention, of making a metal casing includes a feeding apparatus, an etching apparatus, and a forming apparatus. The feeding apparatus supports a roll of metal sheet and sequentially feeds a part of metal sheet from the roll of metal sheet. The etching apparatus is connected to the feeding apparatus and receives the part of metal sheet and etches a plurality of holes on the part of metal sheet. The forming apparatus is connected to the etching apparatus and receives the part of metal sheet and forms the part of metal sheet into the metal casing.

Therein, the forming apparatus includes a surface treating apparatus and a press forming apparatus. The surface treating apparatus is connected to the etching apparatus and receives the part of metal sheet and implements a surface treatment on the part of metal sheet. The press forming apparatus is connected to the surface treating apparatus which receives the part of metal sheet and press forms the part of metal sheet into the metal casing. It is notable that the surface treating apparatus and the press forming apparatus can be exchanged. That is to say, the press forming apparatus is connected to the etching apparatus, and the surface treating apparatus is connected to the press forming apparatus. The press forming apparatus receives the part of metal sheet and press forms the part of metal sheet into a predetermined casing. The surface treating apparatus receives the predetermined casing and implements a surface treatment on the predetermined casing to generate the metal casing.

Moreover, the surface treating apparatus of the invention includes a spray anodizing apparatus. The spray anodizing apparatus includes a nozzle, a solution, a recycle device, and a power supply. The power supply applies a voltage between the part of metal sheet and the nozzle or between the predetermined casing (when the press forming apparatus is connected between the etching apparatus and the surface treating apparatus) and the nozzle. The nozzle atomizes and sprays the solution on the part of metal sheet or the predetermined casing. The recycle device recycles the atomized solution for recycling. The composition of the solution depends on the materials of the part of metal sheet or that of the predetermined casing.

In an embodiment, the metal casing is a front frame of a television, and therein the holes are meshes of a speaker. In another embodiment, the metal casing is a rear cover of the television, and therein the holes are heat dissipating meshes. It is notable that the method and the system of making a metal casing also can be applied to the metal casings of other apparatuses and are not to be limited by the front frame or the rear cover of the television.

Accordingly, the method and the system of making a metal casing according to the invention integrate several processes and continuously make the metal casing to avoid the transportation of intermediate products, to reduce the variations which influence the processes, and to increase the stability of the processes, so as to rise the yield rate of products and lower the unit cost of the products.

The advantage and spirit of the invention may be understood by the following recitations together with the appended drawings.

### BRIEF DESCRIPTION OF THE APPENDED DRAWINGS

FIG. 1A to 1D are schematic diagrams illustrating the system of making a metal casing according to a first preferred embodiment of the invention.

FIG. 2 is a schematic diagram illustrating the system of making a metal casing according to a second preferred embodiment of the invention.

FIG. 3A is a process flow chart showing the first method of making a metal casing according to the invention.

FIG. 3B is a process flow chart showing the second method of making a metal casing according to the invention.

FIG. 3C is a process flow chart showing a step S104 of the foregoing two methods.

### DETAILED DESCRIPTION OF THE INVENTION

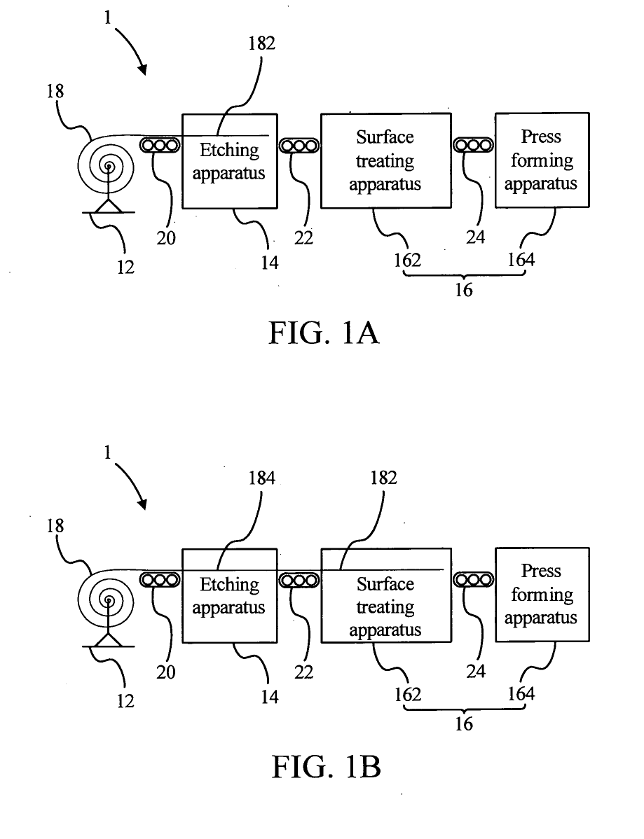

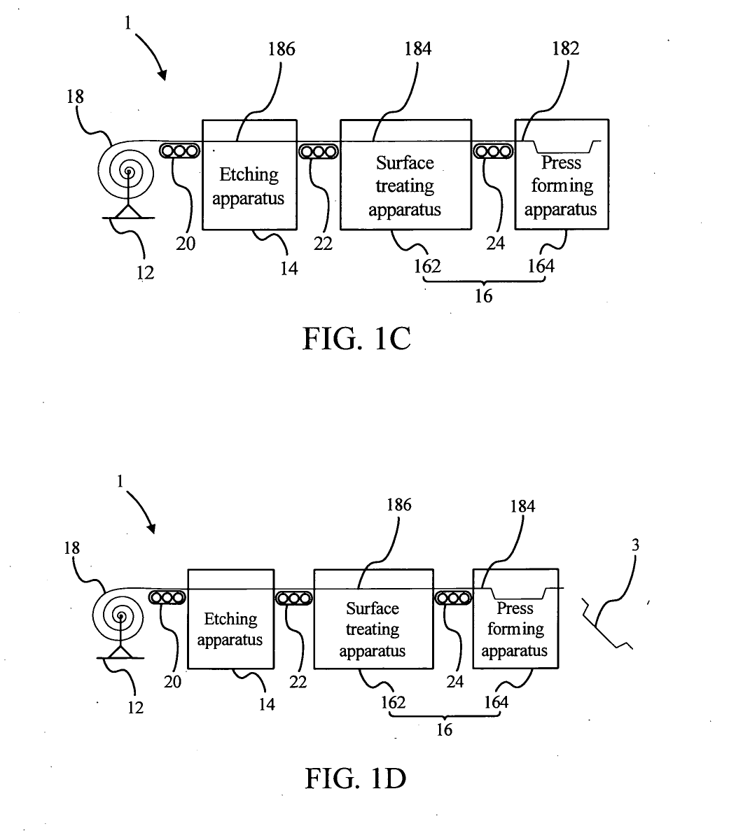

Referring to FIG. 1A to 1D, FIG. 1A to 1D are schematic diagrams illustrating the system 1 of making a metal casing 3 according to a first preferred embodiment of the invention. According to the first preferred embodiment, the system 1 includes a feeding apparatus 12, an etching apparatus 14, and a forming apparatus 16. The forming apparatus 16 includes a surface treating apparatus 162 and a press forming apparatus 164. The feeding apparatus 12 supports a roll of metal sheet 18 and sequentially feeds a part of metal sheet 182 from the roll of metal sheet 18. The etching apparatus 14 is connected to the feeding apparatus 12. The forming apparatus 162 is connected to the etching apparatus 14. The press forming apparatus 164 is connected to the surface treating apparatus 162. According to the first preferred embodiment, as shown in FIG. 1A, the foregoing apparatuses 12, 14, 162, and 164 are connected by several transportation belts 20, 22, and 24. In a practical system design, the transportation belts 20, 22, and 24 also can be replaced by other apparatuses, even though the apparatuses 12, 14, 162, and 164 can be connected by the structures of themselves without other apparatuses. By the way, in a practical system design, if there is a need to integrate other processes, the necessary apparatuses or devices also can be properly connected among the apparatuses 12, 14, 162, and 164. For example, a leveling apparatus is disposed between the feeding apparatus 12 and the etching apparatus 14, additionally for increasing the flatness degree of the part of metal sheet 182.

According to the first preferred embodiment, after being fed by the feeding apparatus 12, the part of metal sheet 182 is received and etched a plurality of holes by the etching apparatus 14. Then, the etched part of metal sheet 182 is transported and received by the surface treating apparatus 162. After receiving the part of metal sheet 182, the surface treating apparatus 162 implements a surface treatment on the part of metal sheet 182. Therein, the surface treatment can be a satin finishing treatment, a sand blasting treatment, a spray anodizing treatment, or a paint baking treatment.

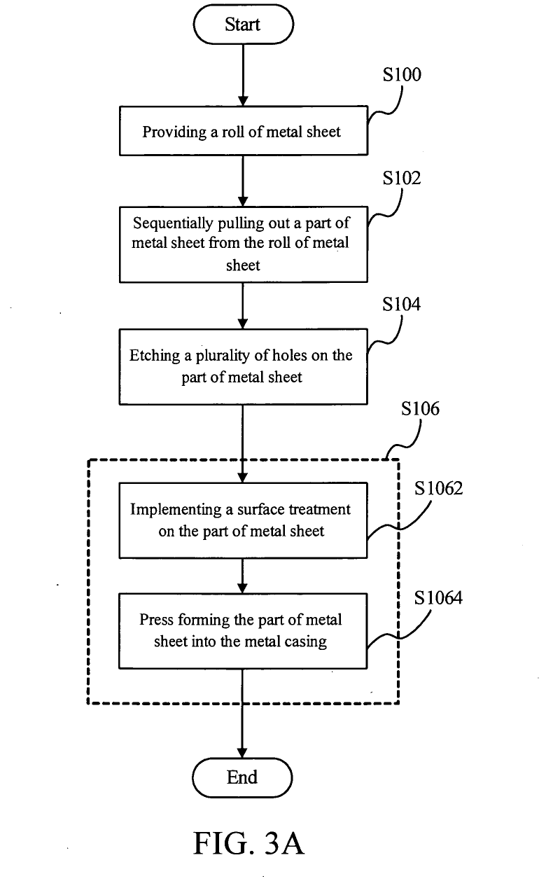

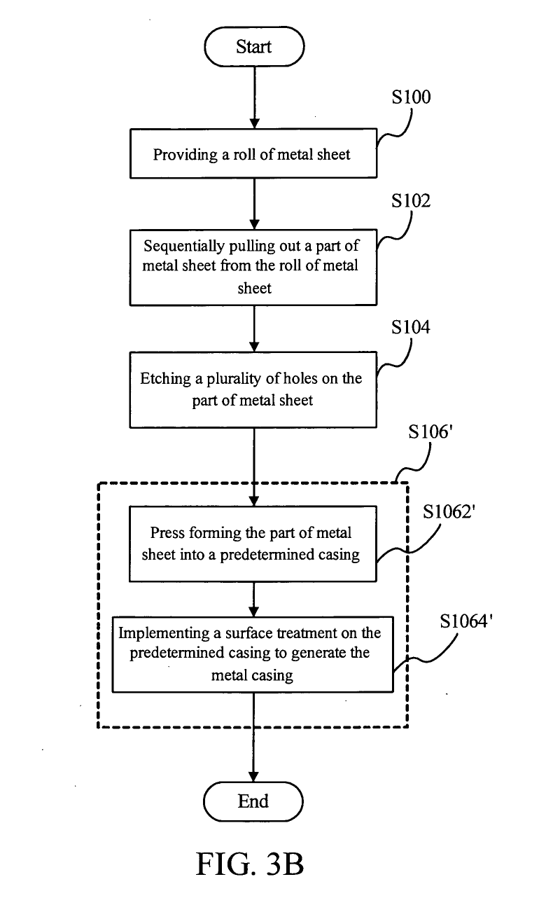

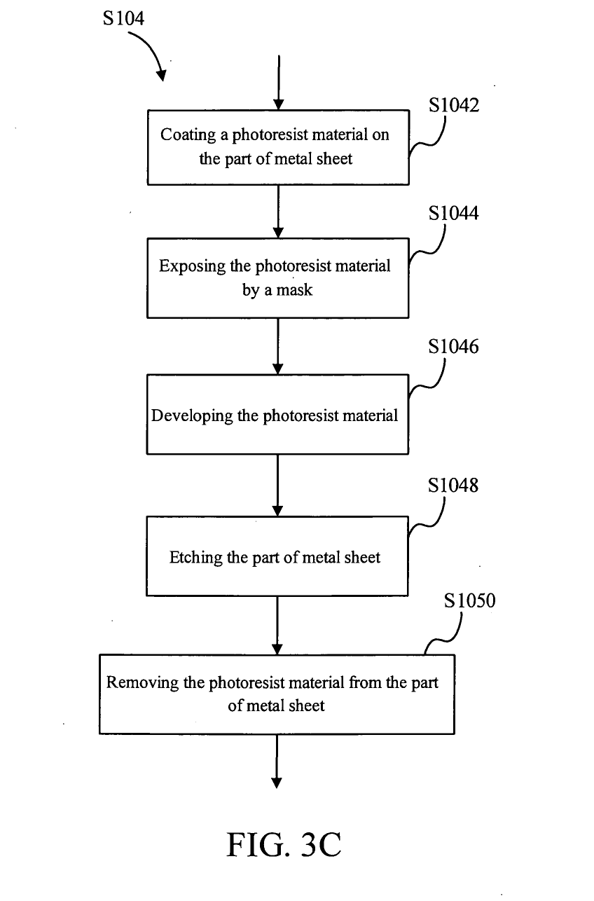

Subsequently, the processed part of metal sheet 182 is then transported and received by the press forming apparatus 164. As shown in FIG. 3, after receiving the part of metal sheet 182, the press forming apparatus 164 forms the part of metal sheet 182 into the metal casing 3. By the way, according to the first preferred embodiment, because the part of metal sheet 182 is first implemented by the surface treatment and then formed, some detriments on the surface of work pieces are induced during the press forming process. Thus, designs of the molds used by the press forming apparatus 164 need to concern this factor, or lubricant can be introduced into the press forming process (and the lubricant is needed to be removed after press forming), or a proper surface treatment is selected to avoid or lower the degree of detriment. These are the prior arts of press forming, so it will not be discussed here.

As shown in FIG. 1B, it is notable that when the part of metal sheet 182 is transported to the surface treating apparatus 162, the feeding apparatus 12 feeds another part of metal sheet 184 to the etching apparatus 14 at the same time. The part of metal sheet 184 continues the part of metal sheet 182 in a rigid body. The etching apparatus 14 applies the same etching process to the part of metal sheet 184 as well as to the part of metal sheet 182. Similarly, as shown in FIG. 1C, when the part of metal sheet 184 is transported to the surface treating apparatus 162, the feeding apparatus 12 feeds another part of metal sheet 186 to the etching apparatus 14. The part of metal sheet 186 continues the part of metal sheet 184 in a rigid body. The etching apparatus 14 also applies the same etching process to the part of metal sheet 186, and the surface treating apparatus 162 also implements the same surface treatment to the part of metal sheet 184 as well as to the part of metal sheet 182. Accordingly, the roll of metal sheet 18 is continuously and sequentially processed by the etching apparatus 14, the surface treating apparatus 162, and the press forming apparatus 164. Furthermore, because the system 1 integrates several different processes and reduces the process variations generated during the transportations of the processes, the system 1 can have better performance of process stability.

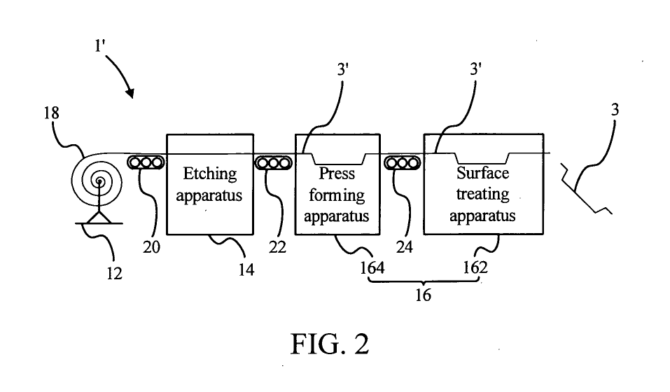

Moreover, referring to FIG. 2, FIG. 2 is a schematic diagram illustrating the system 1′ of making a metal casing according to a second preferred embodiment of the invention. As shown in FIG. 2, compared with the first preferred embodiment, the dispositions of the surface treating apparatus 162 and the press forming apparatus 164 are exchanged. That is to say, the press forming apparatus 164 is disposed between the etching apparatus 14 and the surface treating apparatus 162. Meanwhile, the press forming apparatus 164 first forms the part of metal sheet 182 (not shown in FIG. 2) into a predetermined casing 3′, and then the surface treating apparatus 162 implements a surface treatment on the predetermined casing 3′ to generate the metal casing 3. It is notable that the predetermined casing 3′ implemented by the surface treating apparatus 162 still connect with the roll of metal sheet 18 in principle. In other word, the predetermined casing 3′ does not separate from the roll of metal sheet 18. At this time, the press forming apparatus 164 can first forms a prebreaking location (not shown in FIG. 2) to the predetermined casing 3′, and after the predetermined casing 3′ is implemented by the surface treatment, the metal casing 3 can be derived by breaking the prebreaking location. Furthermore, a cutting apparatus can be disposed within or behind the surface treating apparatus 162 to generate the metal casing 3 or execute foregoing breaking action to derive the metal casing 3. Another approach is that the predetermined casing 3′ formed by the press forming apparatus 164 has separated from the roll of metal sheet 18. Sequentially, the predetermined casing 3′ is transported to the surface treating apparatus 162 and is implemented by the surface treatment to generate the metal casing 3.

Furthermore, in the foregoing preferred embodiment, devices within the surface treating apparatus 162 are different depend on the needed surface treatments. In an embodiment (not shown in figures), the surface treating apparatus 162 includes a spray anodizing apparatus. The spray anodizing apparatus includes a nozzle, a solution, a recycle device, and a power supply. The power supply applies a voltage between the part of metal sheet 182 and the nozzle or between the predetermined casing 3′ and the nozzle. The nozzle atomizes and sprays the solution on the part of metal sheet 182 or the predetermined casing 3′. The recycle device recycles the atomized solution. Accordingly, the concentration of the solution which is sprayed on the part of metal sheet 182 or the predetermined casing 3′ is easy to maintain, the required consumption of the solution is lesser, and exchanging different solutions is convenient. Therein, the composition of the solution depends on the surface treatments which the roll of metal sheet 18 needs. For example, the common anodizing treatment of aluminum, but the invention is not limited by this. The surface treatment is a prior art, so it will not be discussed here.

In an embodiment (not shown in figures), the metal casing is a front frame of a television, wherein the holes are meshes of a speaker. In another embodiment, the metal casing is a rear cover of the television, and wherein the holes are heat dissipating meshes. It is notable that the method and the system of making a metal casing are also applied to the metal casings of other apparatuses and are not to be limited by the front frame or the rear cover of the television.

Referring to FIG. 3A, FIG. 3A is a process flow chart showing the first method of making a metal casing according to the invention. Please refers to the foregoing explanations of the system of making a metal casing of the invention and FIG. 1A to 1D as well. The first method includes steps of:

Step S100: providing a roll of metal sheet;

Step S102: sequentially pulling out a part of metal sheet from the roll of metal sheet;

Step S104: etching a plurality of holes on the part of metal sheet; and

Step S106: forming the part of metal sheet into the metal casing.

Wherein the step S106 includes two steps of:

Step S1062: implementing a surface treatment on the part of metal sheet; and

Step S1064: press forming the part of metal sheet into the metal casing.

Referring to FIG. 3B, FIG. 3B is a process flow chart showing the second method of making a metal casing according to the invention. Please refer to the foregoing explanations of the system of making a metal casing of the invention and FIG. 2 as well. Compared with the first method and respected to the step S106 of the first method, the surface treating step and the press forming step of step S106′ of the second method are exchanged. In other words, the step S106′ of the second method includes steps of:

Step S1062′: press forming the part of metal sheet into a predetermined casing; and

Step S1064′: implementing a surface treatment on the predetermined casing to generate the metal casing.

The surface treatments of foregoing two methods can be a satin finishing treatment, a sand blasting treatment, a spray anodizing treatment, a paint baking treatment, or other surface treatments. Moreover, as shown in FIG. 3C, FIG. 3C is a process flow chart showing the step S104 of the foregoing two methods. The step S104 includes steps of:

Step S1042: coating a photoresist material on the part of metal sheet;

Step S1044: exposing the photoresist material by a mask;

Step S1046: developing the photoresist material;

Step S1048: etching the part of metal sheet; and

Step S1050: removing the photoresist material from the part of metal sheet.

The foregoing step S104 is a traditional etching method whose detail steps are prior arts of etching process, so it will not be discussed here. By the way, the explanations of the same terms which the foregoing two methods and the foregoing system of making a metal casing mention are the same, so they will not be discussed here.

To sum up, the method and the system of making a metal casing of the invention are continuous processes, so the time and the space of transportation can be saved, and the costs and the defective rate can be decreased. Materials are not limited to aluminum roll of sheets, galvanized sheet steels, or other etchable metal materials. Taking a front frame of a television as a sample, meshes of a speaker can be directly produced on the front frame of the television by using the etching method, and it not only can generate integrally formed metal quality but also can etch the meshes of the speaker to generate an amplified synergistic effect of one side larger and another side smaller. And, the anodizing treatment can be exchanged with atomized spraying treatment, so the concentration of the solution is easily to be controlled to improve the yield rate and the manufacturing speed. Moreover, the waste of the middle of the front frame of the television generated by press forming can combine other design (such as a base, a cover, etc.) to improve the utilization of materials and save entire manufacturing time and unit cost of products.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A method of making a metal casing comprising steps of:
(a) providing a roll of metal sheet;
(b) sequentially pulling out a part of metal sheet from the roll of metal sheet;
(c) etching a plurality of holes on the part of metal sheet; and
(d) forming the part of metal sheet into the metal casing.

2. The method of claim 1, wherein the step (d) comprises steps of:
implementing a surface treatment on the part of metal sheet; and
press forming the part of metal sheet into the metal casing.

3. The method of claim 1, wherein the step (d) comprises steps of:
press forming the part of metal sheet into a predetermined casing; and
implementing a surface treatment on the predetermined casing to generate the metal casing.

4. The method of claim claim 2, the surface treatment is one selected from a group consisting of a satin finishing treatment, a sand blasting treatment, a spray anodizing treatment, and a paint baking treatment.

5. The method of claim 1, wherein the step (c) comprises steps of:
coating a photoresist material on the part of metal sheet;
exposing the photoresist material by a mask;
developing the photoresist material;
etching the part of metal sheet; and
removing the photoresist material from the part of metal sheet.

6. A system of making a metal casing, comprising:
a feeding apparatus for supporting a roll of metal sheet and sequentially feeding a part of metal sheet from the roll of metal sheet;
an etching apparatus, connected to the feeding apparatus, for receiving the part of metal sheet and etching a plurality of holes on the part of metal sheet; and
a forming apparatus, connected to the etching apparatus, for receiving the part of metal sheet and forming the part of metal sheet into the metal casing.

7. The system of claim 6, wherein the forming apparatus comprises:
a surface treating apparatus, connected to the etching apparatus, for receiving the part of metal sheet and implementing a surface treatment on the part of metal sheet; and
a press forming apparatus, connected to the surface treating apparatus, for receiving the part of metal sheet and press forming the part of metal sheet into the metal casing.

8. The system of claim 6, wherein the forming apparatus comprises:
a press forming apparatus, connected to the etching apparatus, for receiving the part of metal sheet and press forming the part of metal sheet into a predetermined casing; and
a surface treating apparatus, connected to the press forming apparatus, for receiving the predetermined casing and implementing a surface treatment on the predetermined casing to generate the metal casing.

9. The system of claim claim 7, the surface treating apparatus comprising a spray anodizing apparatus, the spray anodizing apparatus comprising a nozzle, a solution, a recycle device, and a power supply, the power supply applying a voltage between the part of metal sheet and the nozzle or between the predetermined casing and the nozzle, the nozzle atomizing and spraying the solution on the part of metal sheet or the predetermined casing, and the recycle device recycling the atomized solution.

10. The system of claim 6, wherein the metal casing is a front frame of a television, a rear cover of the television, or a casing of an electronic apparatus, and the holes are meshes of a speaker or heat dissipating meshes.

11. The method of claim 3, the surface treatment is one selected from a group consisting of a satin finishing treatment, a sand blasting treatment, a spray anodizing treatment, and a paint baking treatment.

12. The system of claim 8, the surface treating apparatus comprising a spray anodizing apparatus, the spray anodizing apparatus comprising a nozzle, a solution, a recycle device, and a power supply, the power supply applying a voltage between the part of metal sheet and the nozzle or between the predetermined casing and the nozzle, the nozzle atomizing and spraying the solution on the part of metal sheet or the predetermined casing, and the recycle device recycling the atomized solution.
